(19) United States
(12) Patent Application Publication
(10) Pub. No.: US 2008/0194132 A1
(43) Pub. Date: Aug. 14, 2008

(54) Compression bonding structure of an electrical connector

(76) Inventor: Pao-Chu Huang, Sinjhuang City (TW)

Correspondence Address: TROXELL LAW OFFICE PLLC, SUITE 1404, 5205 LEESBURG PIKE, FALLS CHURCH, VA, 22041, US

(21) Appl. No.: 11/905,401

(22) Filed: Sep. 28, 2007

(30) Foreign Application Priority Data
Dec. 15, 2006 (TW) 095222131

(51) Int. Cl. H01R 13/62

(52) U.S. Cl. 439/345

(57) ABSTRACT

A compression bonding structure of an electrical connector is disclosed to include a body having terminal grooves and two coupling grooves at two sides of the terminal grooves, metal terminals mounted in the terminal grooves, each metal terminal having a contact portion and a barbed tip at the end of the contact portion, a cover, which is pivotally coupled to the body and has front bottom protrusions and compressed with the body after insertion of a flexible circuit board in between the cover and the body to corrugate a part of the flexible circuit board and to engage the barbed tips of the metal terminals into the flexible circuit board, keeping the flexible circuit board firmly secured to the body and the cover and the conductors of the flexible circuit board in positive contact with the metal terminals.

### BACKGROUND OF THE INVENTION

1. Field of the Invention

The present invention relates to an electrical connector and more specifically, to a compression bonding structure of an electrical connector, which has protrusions extending from the bottom edge of the cover for crimping a flexible circuit board between the cover and the body to have the flexible circuit board be bonded to the cover and the body and the barbed tips of the metal terminals of the electrical connector be engaged into the surface of the flexible circuit and kept in positive contact with respective conductors in the flexible circuit board.

2. Description of the Related Art

An electrical connector is a connection device for connecting electrical cables, circuit boards, electronic devices, etc. Therefore, electrical connectors are intensively used in different electronic products such as notebook computers, PDAs, etc.

An electrical connector may be soldered to a circuit board, keeping its metal terminals electrically connected to respective circuit contacts in the circuit board. An electrical connector may be used to connect a flexible circuit board to a hard circuit board for signal transmission between the flexible circuit board and the hard circuit board.

The compression bonding structure of an electrical connector for connection to a flexible circuit board is known comprising a body holding a set of metal terminals, and a cover covered on the body to sandwich a flexible circuit in between the body and the cover. The cover has a flat bottom surface, which is closely attached to the top surface of the flexible circuit board. When the body with the cover and the flexible circuit board are compressed, the barbed tips of the metal terminals for forced into the surface of the flexible circuit board to secure the flexible circuit board to the body and the cover and to keep the metal terminals in positive contact with respective conductors in the flexible circuit board. This compression bonding structure is still not satisfactory in function. Because the top surface of the flexible circuit board and the bottom surface of the cover are flat surfaces, the engagement force between the cover and the flexible circuit board is not strong enough, and the flexible circuit board may be forced away from the cover and the body accidentally.

### SUMMARY OF THE INVENTION

The present invention has been accomplished under the circumstances in view. It is therefore the main object of the present invention to provide a compression bonding structure of an electrical connector, which has protrusions extending from the bottom edge of the cover for crimping a part of the loaded flexible circuit board as the barbed tips of the metal terminals of the electrical connector are forced into the surface of the flexible circuit board, thereby securing the flexible circuit board firmly to the cover and body of the electrical connector and keeping the metal terminal of the electrical connector in positive contact with respective conductors in the flexible circuit board.

To achieve this and other objects of the present invention, the compression bonding structure of an electrical connector for compression-bonding to a flexible circuit board is comprised of a body, a cover, and a plurality of metal terminals. The body comprises a plurality of terminal grooves forwardly extending to the front side, two coupling grooves respectively disposed near two opposite lateral sides relative to the terminal grooves, the coupling grooves each having an open side, and two retaining members respectively suspending in the open sides of the coupling grooves. The cover is movably set in the coupling grooves of the body, having two pivots respectively slidably inserted into the coupling grooves and connectable to the retaining members for allowing pivot motion of the cover relative to the body, a plurality of bottom notches corresponding to the terminal grooves of the body, and a plurality of protrusions respectively disposed between each two adjacent ones of the bottom notches. The metal terminals are respectively mounted in the terminal grooves of the body, each having a contact portion and a barbed tip extending from the contact portion. When a flexible circuit board is inserted in between the cover and the body, the cover is turned downwards and closed on the flexible circuit board, and then the cover with the body and the flexible circuit board are compression-bonded together to force the barbed tips of the metal terminals and the protrusions of the cover against the flexible circuit board, thereby corrugating a part of the flexible circuit board and engaging the barbed tips into the flexible circuit board and keeping the barbed tips in positive contact with respective conductors in the flexible circuit board.

### BRIEF DESCRIPTION OF THE DRAWINGS

FIG. 1 is an exploded view of a compression bonding structure of an electrical connector according to the present invention.

FIG. 2 is a schematic drawing showing a flexible circuit board inserted in between the body and cover of the compression bonding structure of the electrical connector according to the present invention.

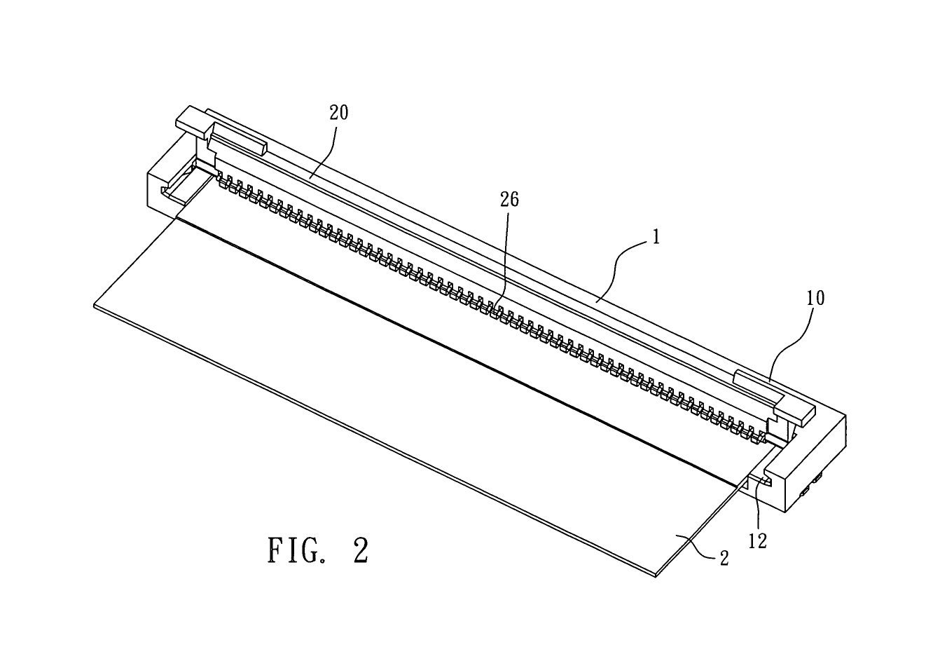

FIG. 3 corresponds to FIG. 2, showing the flexible circuit board bonded to the cover and body of the compression bonding structure of the electrical connector according to the present invention.

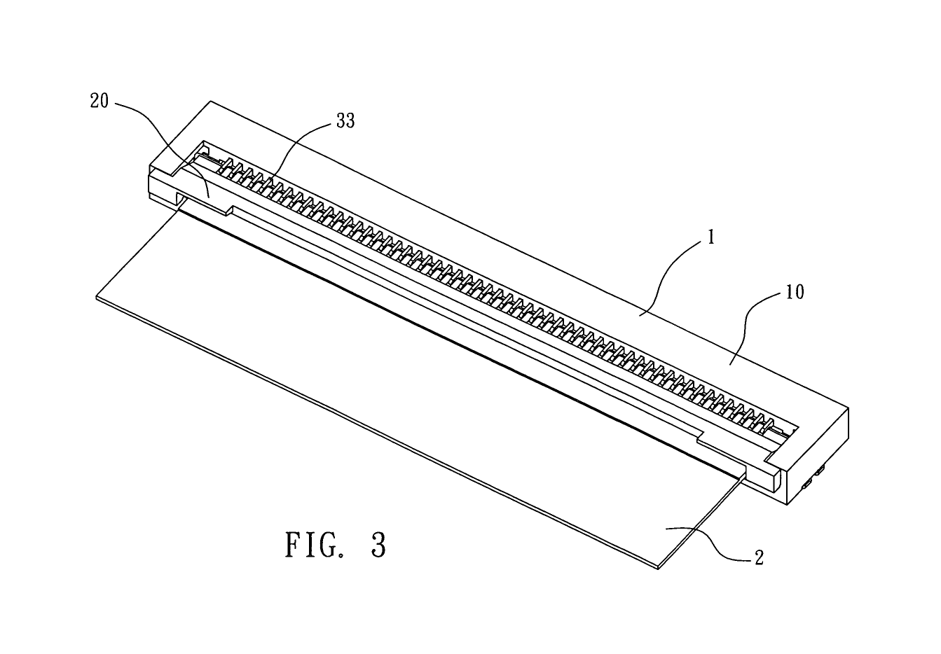

FIG. 4 is a schematic enlarged view of a part of FIG. 3, showing the protrusions of the cover and barbed tips of the metal terminals engaged into the flexible circuit board according to the present invention.

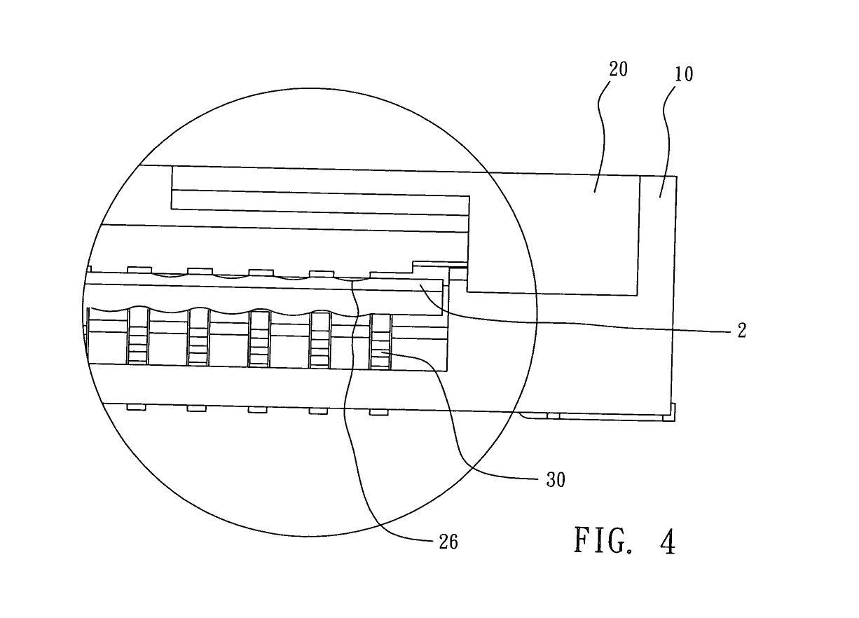

### DETAILED DESCRIPTION OF THE PREFERRED EMBODIMENT

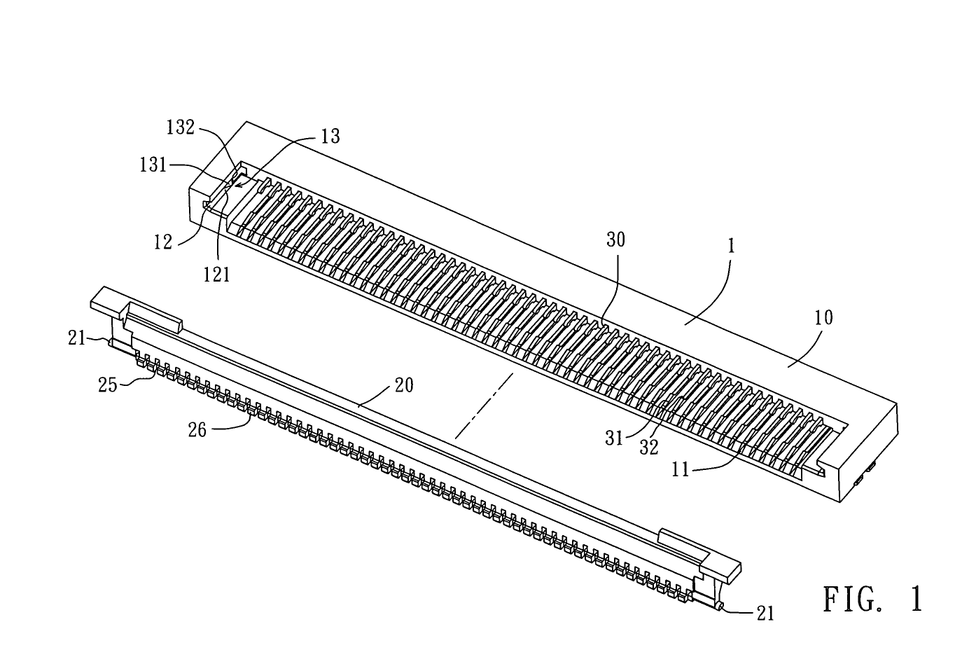

Referring to FIGS. 1˜4, a compression bonding structure of an electrical connector 1 is shown connected to a flexible circuit board 2. The electrical connector 1 is comprised of a body 10, a cover 20, and a set of metal terminals 30.

The body 10 has a set of terminal grooves 11 arranged in its front side, two coupling grooves 12 respectively disposed near its two opposite lateral sides, and two retaining members 13 respectively disposed near its two opposite lateral sides and respectively suspending in the open side 121 of each of the coupling grooves 12. The retaining members 13 each have two beveled surfaces 131 and 132 at two opposite sides for guiding the cover 20 over the retaining members 13 when the cover 20 is moved in the coupling grooves 12. Further, elastic means, for example, springs (not shown) are respectively disposed in the open side 121 of each of the coupling grooves 12 beneath the respective retaining members 13 to support the respective retaining members 13, allowing vertical movement of the respective retaining members 13 relative to the body 10.

The cover 20 is movably set in the coupling grooves 12 of the body 10, having two pivots 21 respectively slidably inserted into the coupling grooves 12 and connectable to the retaining members 13 for allowing pivot motion of the cover 20 in vertical direction relative to the body 10. The cover 20 further has a plurality of bottom notches 25 corresponding to the terminal grooves 11 of the body 10, and a protrusion 26 between each two adjacent bottom notches 25. The number and locations of the bottom notches 25 are preferably determined subject to the number and locations of the terminal grooves 11 such that the metal terminals 30 are exposed to the outside after installation of the metal terminals 30 in the terminal grooves 11 and the cover 20 in the body 10. Further, the protrusions 26 extend outwardly from the bottom edge of the cover 20 between each two adjacent bottom notches 25. Further, the body 10 and the cover 20 are respectively molded from an electrically insulative material, for example, plastics.

The metal terminals 30 are respectively mounted in the terminal grooves 11 of the body 10, each having a contact portion 31 and a barbed tip 32 at the end of the contact portion 31. The barbed tips 32 of the metal terminals 30 are respectively exposed to the bottom notches 25 of the cover 20 for cutting into the flexible circuit board 2 to make contact with a respective conductor (not shown) in the flexible circuit board 2.

When assembling the body 10 and the cover 20, insert the pivots 21 of the cover 20 into the coupling grooves 12 of the body 10 respectively to force the pivots 21 over the retaining members 13 along the beveled surfaces 131, enabling the pivots 21 to be pivotally secured to the coupling grooves 12 of the body 10 by the retaining members 13.

When the flexible circuit board 2 is inserted in between the body 10 and cover 20 of the electrical connector 1, the cover 20 is turned downwards and covered on the flexible circuit board 2 to hold the barbed tips 32 of the metal terminals 30 in close contact with the flexible circuit board 2, and then the electrical connector 1 with the flexible circuit board 2 are compressed to engage the barbed tips 32 of the metal terminals 30 into the top surface of the flexible circuit board 2 and to stop the protrusions 26 against the top surface of the flexible circuit board 2, therefore the flexible circuit board 2 is corrugated and firmly secured to the body 10 and the cover 20, keeping the barbed tips 32 of the metal terminals 30 in positive contact with the respective conductors in the flexible circuit board 2.

As stated above, the cover has protrusions outwardly extending from its bottom edge. The protrusions and the barbed tips of the metal terminals are crimped to the flexible circuit board, securing the flexible circuit board firmly to the body and cover of the electrical connector and ensuring positive contact between the metal terminals and the respective conductors in the flexible circuit board.

Although a particular embodiment of the invention has been described in detail for purposes of illustration, various modifications and enhancements may be made without departing from the spirit and scope of the invention.

What is claimed is:

1. A compression bonding structure of an electrical connector for compression-bonding to a flexible circuit board, comprising:
a body, said body comprising a plurality of terminal grooves forwardly extending to a front side thereof, two coupling grooves respectively disposed at two opposite lateral sides relative to said terminal grooves, said coupling grooves each having an open side, and two retaining members respectively suspending in the open sides of said coupling grooves;
a cover movably set in the coupling grooves of said body, said cover having two pivots respectively slidably inserted into said coupling grooves and connectable to said retaining members for allowing pivot motion of said cover relative to said body, a plurality of bottom notches corresponding to the terminal grooves of said body, and a plurality of protrusions respectively disposed between each two adjacent ones of said bottom notches; and.
a plurality of metal terminals respectively mounted in the terminal grooves of said body, said metal terminals each having a contact portion and a barbed tip extending from said contact portion;
wherein when a flexible circuit board is inserted in between said cover and said body, said cover is turned downwards and closed on said flexible circuit board, and then said cover with said body and said flexible circuit board are compression-bonded together to force said barbed tips of said metal terminals and said protrusions of said cover against said flexible circuit board, thereby corrugating a part of said flexible circuit board and engaging said barbed tips into said flexible circuit board and keeping said barbed tips in positive contact with respective conductors in said flexible circuit board.

2. The compression bonding structure of an electrical connector as claimed in claim 1, wherein said retaining members each have two beveled surfaces at two opposite sides for guiding the pivots of said cover over said retaining members.

3. The compression bonding structure of an electrical connector as claimed in claim 2, wherein said body further comprises two elastic members respectively disposed in the open sides of said coupling grooves to support said retaining members in the open sides of said coupling grooves.

4. The compression bonding structure of an electrical connector as claimed in claim 3, wherein said elastic members are compression springs.

5. The compression bonding structure of an electrical connector as claimed in claim 1, wherein the number of said protrusions is equal to the number of said terminal grooves and the number of said metal terminals.

6. The compression bonding structure of an electrical connector as claimed in claim 1, wherein said protrusions extend outwardly from a bottom edge of said cover.

7. The compression bonding structure of an electrical connector as claimed in claim 1, wherein said cover and said body are respectively made out of an electrically insulative material.

8. The compression bonding structure of an electrical connector as claimed in claim 7, wherein said electrically insulative material is a plastic material.
